(19) United States
(12) Patent Application Publication
(10) Pub. No.: US 2006/0189904 A1
(43) Pub. Date: Aug. 24, 2006

(54) Apparatus for applying creams/lotions

(76) Inventors: Eugene Owvighofimoni Okoro, London (GB); Evelyn Ogochukwu Okoro, London (GB)

Correspondence Address: HESLIN ROTHENBERG FARLEY & MESITI PC, 5 COLUMBIA CIRCLE, ALBANY, NY, 12203, US

(21) Appl. No.: 11/064,159

(22) Filed: Feb. 23, 2005

(51) Int. Cl. A61H 15/00

(52) U.S. Cl. 601/19; 601/17

(57) ABSTRACT

This invention relates to an applicator (1, 10b) for self application of lotions and creams to the back of a user. The applicator comprises a body section (2) having a non absorbing encasement (4), and located at each end thereof a handle (3). The body section (2) of the applicator (1. 10b) can be rotated with respect to the handles so that the body section (2) of the applicator (1, 109b) may be rolled over the back to effect dispersion of the lotion and/or cream applied to the surface of the encasement.

This invention relates to apparatus for the self application of creams and/or lotions to the back of a patient and a method of self application thereof.

Apparatus for and methods of self application of creams and lotions have been previously proposed. Commonly these methods and apparatus are quite complex and difficult to use for a patient and particularly a patient with a sore back and restricted movement.

A typical example of one such self applicator is shown in U.S. Pat. No. 5,736,213 Meier. U.S. Pat. No. 5,736,213 shows an applicator having an elongate body section with fixed loop type handles located at each end. The body section has a skin formed from a non-absorbent material such as Poly Vinyl Chloride and defining an inner space in which is located a number of massager balls and spacers. The overall shape of the applicator rectangular which means the applicator is designed to be drawn back forth across the body.

In use the applicator has lotion applied to the surface thereof. The applicator is then located about the back of the user and held in place by the user using the handles provided. By applying force to the applicator it can be moved from side to side across the back of the user, and by application of judicious force and movement can be moved up and down the length of the back as well. The lotion applied to the skin by the applicator is thereby distributed over the back area and via the balls within the inner space massaging action is applied to the back.

The drawbacks in using this basic type of device stem from the handle arrangement. The fixed handle arrangement makes it difficult to work the applicator in a fashion to move it up and down the back and any up and down movement has to be achieved with side to side motion. Use of this type of applicator is not as straight forward and easy as people would hope. This can be particularly true where the applicator is being used by someone who has limited movement from something such as back pain.

The object of the present invention is to provide apparatus and a method for applying creams and lotions to the back in which these drawbacks are alleviated or at the least significantly reduced.

In accordance with a first aspect of the invention there is provided an applicator for the application of lotions/creams, which applicator comprises a body section having a non absorbing encasement; two handles rotatable and located at each end thereof a handle wherein in use the body section of the applicator can be rotated with respect to the handles so that the body section of the applicator may be rolled over the back to effect dispersion of the lotion and/or cream.

The applicator is intended to allow for self application, so that a user can apply lotions and/or creams without having to rely on a third party. By their very nature self applicators are never very easy to use, and in this case the aim is to make such use simpler and easier. This is of particular importance when you consider that a fair proportion of the users of this type of applicator will be by people having back problems and pain which may restrict their movement.

The applicator may be provided with massaging balls/rollers located within the encasement so that when the body section is rotated the balls perform a massaging function as they roll over the back.

There is also available single hand operated applicator whereby the user holds the applicator by stretching over his own shoulder. This can be very strenuous and cumbersome and the operation of the applicator will not generally achieving the desired aim.

In one particular arrangement of the present invention the balls/rollers are located on a flexible skeleton or framework about which the encasement is disposed. In use the skeleton will need to flex as it is moved to provide efficient working. In one example the flexible skeleton is formed from wood, such as piping cord.

The encasement is a non absorbing encasement which forms a cover about the flexible skeleton. The encasement and the skeleton may be formed as one unitary component or as separate parts.

The handle may be formed as a simple extension of the encasement and/or the flexible skeleton. In an alternative arrangement the handle comprises a shaped member, preferably a conical shaped member which is provided with means for fixing the encasement at one end.

The shaped member of the handle may be formed as a solid wooden member, or from any other suitable material which will accept pressure from the hand in use. The shaped member may also be provided with decorative panels such as painted sections or porcelain inlays.

The massaging balls may be wooden beads.

The applicator may also include means for dispensing and applying lotion and/or creams to the back as the applicator is used.

The dispensing means may comprise a boat and roller arrangement located in a pocket in the applicator with the surface of the collar exposed for dispensing of cream and/or lotion located in the boat.

The invention will now be described by way of examples with reference to the accompanying drawings: in which:

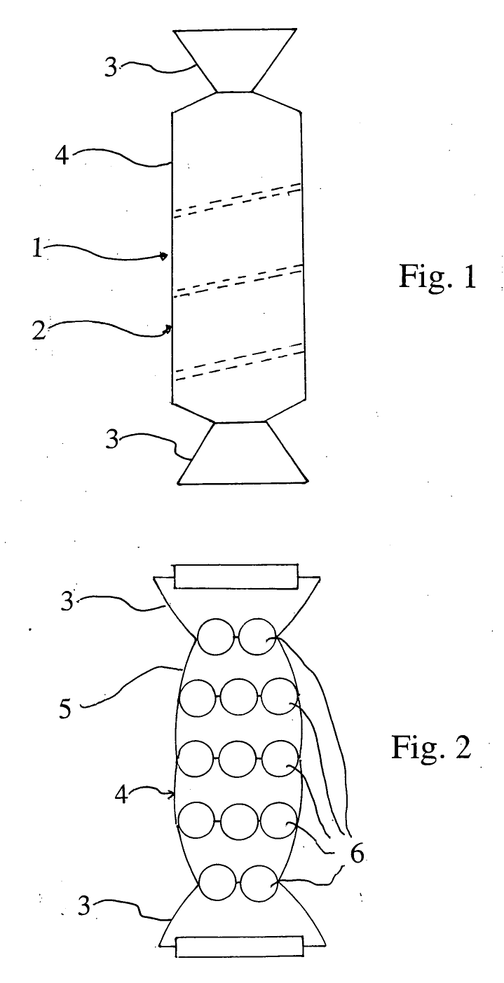

FIG. 1 shows a side view of a flat applicator made in accordance with the drawings;

FIG. 2 shows a side view of the flexible skeleton on the applicator shown on FIG. 1; and

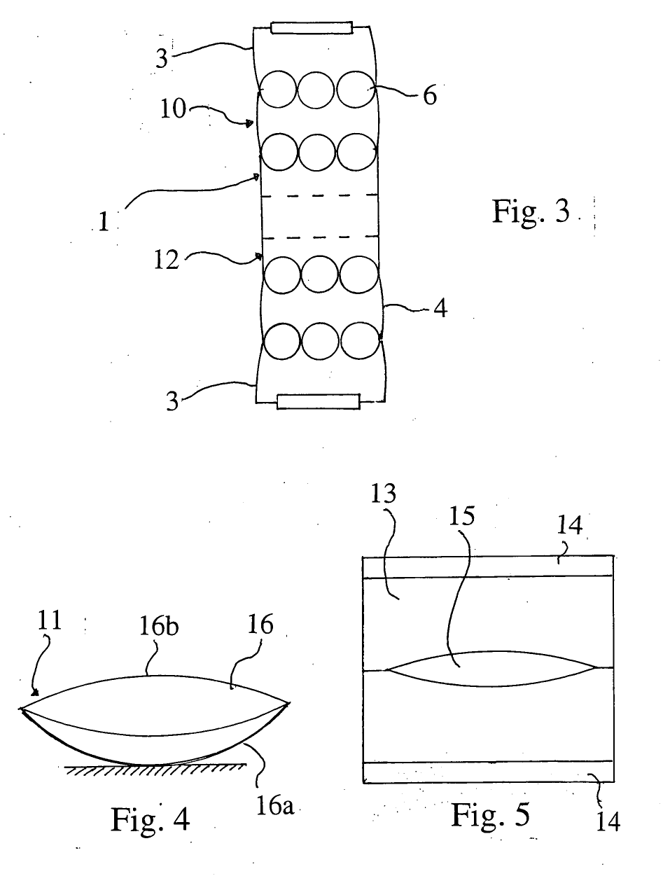

FIGS. 3 to 5 show views of a second applicator made in accordance with the present invention and component parts thereof.

Now referring to the drawings, there is shown in FIGS. 1 and 2. An applicator 1 made in accordance with the present invention and suitable for the application of lotions and/or creams to the back of a user.

The applicator 1 is of a tubular structure and has a body section 2 with handles 3 at each end thereof. The applicator 1 comprises an encasement 4 which defines an inner space 4a and a skeletal framework 5.

The encasement 4 preferably is supple and flexible in nature. The encasement 4 may be made of a non woven material which is non absorbent of the lotions and creams to be applied and used with the applicator. Suitable materials for the encasement 4 include synthetic materials and coated materials, for example Poly Vinyl Chloride or a suitable treated leather.

The skeletal framework 5 in this particular example is formed from a cord like material such as piping cord and provides a framework for the location of massaging balls 6 provided on the applicator. The skeletal framework 5 and the massaging balls 6 are located in the inner space of the applicator 1 so that they are covered by the encasement 4.

The handles 3 provide simple means to move and manipulate the applicator 1 and comprise wooden conical shaped members which at the upper end thereof are provided with means for attachment of the encasement 4. Theses means (not shown in detail in the drawings) may comprise a simple groove into which the encasement 4 and or the skeletal framework 5 are secured.

The handles provide an extension of the encasement 4 which may be easily held by the user for the purpose of using the applicator.

To use the applicator 1, it is assembled as described above and as shown in FIGS. 1 and 2 of the drawings. It is best used before or after a bath or a swim and is used as follows:

1. Lay the device on a flat surface, e.g. on a bed or table, with the handles opened out i.e. with cord not crossed or twisted on both sides.

2. Hand spread or squeeze some desired drops of the lotion and/or cream along the surface of the device and spread it evenly over the surface of the encasement 4.

3. With each hand opened out back to back each other facing out, grip the device by the handles 3 and lift over your head on to your back. This approach is important because if you attempt to lift the device as if you were carrying or lifting an object to your back, you will not be able to lower the device and it will be twisted on your back and so not work efficiently.

4. Continue movement until you have reached all the parts you desire to reach and the device is free of the substance.

The applicator and encasement 4 can be washed with liquid soap and water, and a soft scrubbing brush to remove any dirt or grease if required.

Now referring to FIGS. 3 to 5 of the drawings. There is shown an alternative applicator 10. The applicator 10 is very similar to applicator 1 described above and like numerals have been used to describe like components.

Applicator 10 differs from applicator 1 in that it is provided with a self cream dispenser 11. The self cream dispenser 11 is located in a pocket provided in the body section 12 of the applicator when the applicator 10 is in use. In the example shown one self cream dispenser is shown centrally located in the applicator 10 although two or more may be located along the length of the applicator.

The encasement 4 of the applicator 10 is provided with a centrally located hood 13 (see FIG. 5) to cover the pocket and which may be secured in position via Velcro strips 14 and is provided with an opening 15.

The self applicator 10 (see FIG. 4) comprises in the embodiment shown a boat and roller arrangement 16. The boat is comprised of a container for holding the cream or lotion to be dispensed and applied to the back of the patient and has an opening cover in which the roller 16 is located. The roller 16 is located so that it will prevent leakage of the cream or lotion from the boat 15 unless it is rotated, when a thin layer of the cream or lotion will be dispensed onto the surface of roller 16 for dispensing onto the back of the patient.

It is important to note that the material of the hood should not interfere with the roller 16 otherwise it will interfere with the dispensing of the cream and/or lotion onto the patients back.

When assembled in the applicator 10, the boat 16a is located in the pocket in the body section 12 so that roller 16b is positioned in the opening 15 in the hood 13. The roller 16b is set in place on the boat 16a by means of two pins, one either side, and on which the roller 16b rotates. The roller 16b is closely located with respect to the opening 15 in the boat 16a thereby dispensing the cream and/or lotion from the boat, as the applicator 10 is moved up and down the back even more so when the boat is tilted and is pressed against the body and moved. By the opening 15 of the hood the surface of the roller 16b is just exposed to allow the area of the roller 16b to touch the body. When the equipment is moved up and down, or according to a preferred movement the cream is rolled out of the boat 16a on to the body. This is done until sufficient cream is dispensed. The other side of the product can then be used to properly spread the cream smoothly over a preferred area.

The operation and usage of the applicator 10 is much the same as that described for applicator 1, except when cream or lotion is to be dispensed for application to the above mentioned area, the cream application method described above with reference to FIGS. 1 and 2 of the drawings above is utilised. This can be done as often as is necessary.

The advantage of using a self cream applicator is that it provides a neater and less messy operation. It also enables prescribed lotions gels or creams to be used.

1. An applicator for the application of lotions and creams, which applicator comprises a body section having a non absorbing encasement; two handles, rotatably mounted one at each end of the body section; and means for dispensing and applying lotions/creams which means comprises a boat and roller arrangement located in the body section with the surface of the roller exposed for dispensing of the cream/lotion from the boat wherein the body section of the applicator can be rotated with respect to the handles so that the body section of the applicator may be rolled over the back to effect dispersion of the lotion and/or cream.

2. An applicator as claimed in claim 1, wherein massaging balls/rollers are located within the encasement so that when the body section is rotated the balls perform a massaging function as they roll over the back.

3. An applicator as claimed in claim 2, wherein the balls/rollers are located on a flexible skeleton or framework about which the encasement is disposed.

4. An applicator as claimed in claims 3, wherein the encasement and the skeleton are formed as one unitary component.

5. An applicator as claimed in claims 2, wherein the encasement and the skeleton are formed as separate parts.

6. An applicator as claimed in claim 1, wherein the handles are formed as an extension of the encasement and/or the flexible skeleton.

7. An applicator as claimed in claim 1, wherein the handle comprises a shaped member which is provided with means for fixing the encasement at one end thereof.

8. An applicator as claimed in claim 7, wherein the shaped member is a conical shaped member.

9. An applicator as claimed in claim 7, wherein the shaped member of the handle is a solid wooden member.

10. An applicator as claimed in claim 9, wherein the shaped member is provided with decorative panels.

11. An applicator as claimed in claim 2, wherein the balls/rollers are wooden beads.
